(19) United States
(12) Patent Application Publication
(10) Pub. No.: US 2012/0323556 A1
(43) Pub. Date: Dec. 20, 2012

(54) SYSTEM AND METHOD FOR USING PINYIN AND A DYNAMIC MEMORY STATE FOR MODIFYING A HANYU VOCABULARY TEST

(76) Inventors: Ti-Chih CHEN, New Taipei City (TW); Meng-Tien Wu, New Taipei City (TW)

(21) Appl. No.: 13/161,139

(22) Filed: Jun. 15, 2011

(51) Int. Cl. G06F 17/28

(52) U.S. Cl. 704/3; 704/E11.001

(57) ABSTRACT

A system and method for using pinyin and a dynamic memory state for modifying a Hanyu vocabulary test are provided. The system uses a Chinese input method for conducting the Hanyu vocabulary test, and includes an input device, an output device, a computing processing device, and a word database. The computing processing device includes a user login verification unit, a screening and sampling unit, a grading and timing unit, and a recording and analyzing unit. The user uses the input device and output device to operate the system. After the user is verified by the user login verification unit, the screening and sampling unit samples a test bank from the word database based on the test record of the user. The grading and timing unit calculates the answering time and determines if the user has answered the questions correctly. The recording and analyzing unit records and analyzes a test result of the user, and then stores the test result to the word database.

### BACKGROUND OF THE INVENTION

1. Field of the Invention

The present invention relates to a system and method for learning a Hanyu Pinyin input method, in which pinyin symbols are used to represent a Chinese character to help a user spell correctly. The system also provides network connections for users to compete with each other online, thereby enhancing learning effects and learning interests through the thrill and sense of honor stimulated by online competition.

2. Description of the Prior Art

A traditional Hanyu vocabulary test is usually performed as a test on paper, and results are provided after the test has been completed. This kind of test does not take into account that the user may make some progress after a long term study and that the user could improve their accuracy rate as additional vocabulary is memorized. In addition, it takes a long time to finish the test and requires a tutor or examiner to be present to assist the user, thereby making it difficult to duplicate the test and perform process monitoring.

Learning a language requires constant practice and progressive learning materials in order to be skilled in both verbal and written communication. Therefore, it is necessary to continuously provide additional resources in order for a user to learn Chinese. There are presently various kinds of Chinese input methods, such as the Cangjie input method, DaYi input method, or Boshiamy input method. These methods allow a user to input radicals to form a Chineses character. Other methods, such as the Zhuyin or Hanyu Pinyin input methods, use phonetic symbols to represent a Chinese character. A single Chinese character can have a plurality of meanings and different characters can have the same pronunciation. Also, a single characters can have multiple pronunciations. For example, “ [symbol] ” can be pronounced as “Zhe” or “Zhou”, “ [symbol] ” can be pronounced as “Le” or “Yue”, and “ [symbol] ” can be pronounced as “Huei” or “Kuai”. These different pronunciations correspond with different meanings. Furthermore, there are four tones in Mandarin Chinese, making it difficult for a beginner to pronounce and write Chinese characters. Therefore, it is necessary for a beginner learning Chinese to use the pinyin input method to pronounce the characters and to spell the phonetic representation of the characters. A major difference between Chinese and English is that the spelling of an English word also represents the pronunciation of the word, whereas the Chinese pinyin system is only a tool to assist a user in recognizing the characters.

Online learning has become an important tool for users to learn languages. A user can learn a language and take tests online to assess his or her current level through test results. A common Chinese character input learning system only trains the user to type faster and to enhance their accuracy rate through repeated practicing. Furthermore, the common Chinese character input learning system typically provides random questions from a single test bank for the user to repeatedly practice the lessons and learn the language. However, it is possible for a user to spend a large amount of time practicing the same lessons without knowing his or her current skill level or ability in using the language, as the lessons are randomly selected and cannot be adjusted based upon the current skill level of the user. In other words, the traditional learning input system is not specifically designed or customized based upon the user. In addition, the traditional learning system is usually designed for only one person to operate at the same time and fails to provide interaction with other users, and may therefore be boring for the user. In order to learn Chinese well, it is important to design a Chinese character input learning system according to the preference of a user, since each person has a different education background, working experience, age, and gender, so the user may prefer to use vocabularies which are specific for his or her personal life, profession, region and so on. Therefore, it is necessary to provide a learning database which is dynamic and adaptable based on the user's current level since a common database can not meet the requirements of all users.

### SUMMARY OF THE INVENTION

A system using pinyin and a dynamic memory state for modifying a Hanyu vocabulary test is provided, whereby the system uses a Chinese input method for conducting the Hanyu vocabulary test. An input device is provided for a user to operate the system therewith, and an output device is provided for displaying a view of the system operation. A computing processing device is also provided, which comprises a user login verification unit for verifying an identity of the user and a test record of the user. The computer processing device also provides a screening and sampling unit for screening a dynamic data storage based on a ratio rule obtained from a test record of the user and for sampling words and phrases from the dynamic data storage to obtain a test bank. A grading and timing unit is provided for determining if the user answers the questions correctly, and for calculating an answering time. A recording and analyzing unit is provided for recording a dynamic IP of a word or phrase and the test record of the user, and for analyzing a word familiarity level and a learning effect of the user. A word database is provided for storing word data of a user, such as a word or a phrase, wherein the user uses the input device and output device to operate the system. After the user is verified by the user login verification unit, the screening and sampling unit samples a test bank from the word database based on the test record of the user. The grading and timing unit calculates the answering time and determines if the user has correctly answered the questions, and the recording and analyzing unit records and analyzes a test result of the user, and then stores the test result to the words database.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a structural view of a system for using pinyin and a dynamic memory state for modifying a Hanyu vocabulary test according to the present invention;

FIG. 2 illustrates a decision flow diagram for determining a word familiarity level of the system for using pinyin and a dynamic memory state for modifying a Hanyu vocabulary test according to the present invention;

FIG. 3 illustrates a structural view of the system for using pinyin and a dynamic memory state for modifying a Hanyu vocabulary test, wherein the structural view shows how the system categorizes new words and/or phrases and acquires new words and/or phrases from different resources;

FIG. 4 illustrates a statistics table of the system for using pinyin and a dynamic memory state for modifying a Hanyu vocabulary test, wherein the table shows a sampling ratio according to a different scenario;

FIG. 5 illustrates a block diagram of the system for using pinyin and a dynamic memory state for modifying a Hanyu vocabulary test according to the present invention;

FIG. 6 illustrates a flow diagram of the system for using pinyin and a dynamic memory state for modifying a Hanyu vocabulary test according to the present invention; and

FIGS. 7A, 7B, and 7C illustrate error rate diagrams of the system for using pinyin and a dynamic memory state for modifying a Hanyu vocabulary test according to the present invention.

1 system for using pinyin and dynamic memory state for modifying a Hanyu vocabulary test
2 user
10 input device
11 home computer
12 tablet PC
13 smart phone
14 PDA
20 output device
30 computing processing device
31 user login verification unit
32 screening and sampling unit
32 grading and timing unit
34 recording and analyzing unit
40 word database
41 new word database
42 unfamiliar word database
43 familiar word database
44 short-term word database
45 long-term word database
50 network device
61 system built-in test bank
62 personalized test bank
63 tutor specified test bank
64 adding other learning material

### DETAILED DESCRIPTION OF THE PREFERRED EMBODIMENT

A method and system for using pinyin and a dynamic memory state for modifying a Hanyu vocabulary test are provided. An object of the present invention is to help a user learn Chinese by taking tests in a game setting, wherein the system is designed to work with a personalized database of the user and permits the user to use a keyboard or other input tool to take the test. The test uses a Chinese input method to represent a Chinese character with pinyin symbols.

An input device is provided for a user to operate the system. The input device can be a keyboard, mouse, touch screen or the like, and the input device lets the user input Chinese pinyin symbols.

An output device is provided for displaying a view of the operation of the system, and the output device can be an LCD display, a touch screen, or the like.

A computing processing device is provided which acts as a computing center of the system.

The computer processing device includes a user login verification unit for verifying an identity of the user and a test record of the user. If the user is a new user to the system, the user login verification unit creates a new data file for the user. A screening and sampling unit is also provided for screening a dynamic data storage based on a ratio rule obtained from a test record of the user and for sampling words and/or phrases from the dynamic data storage to obtain a test bank. The ratio rule is determined with respect to a single user, one-to-one, and multiple user test. The system samples words and/or phrases fairly from a word database of a user according to the ratio rule. In other words, the system samples the words and/or phrases to design a test having the same difficulty level to all users.

A grading and timing unit is provided for determining if the user answer the questions correctly and for calculating an answering time according to the IPs of the words and/or phrases in the word database.

A recording and analyzing unit is provided for recording a dynamic IP of a word or phrase and for the test record of the user, and for analyzing a word familiarity level and a learning effect of the user. The learning effect is defined as the time it takes for a word or phrase to be in the long-term word database after its first appearance. The recording and analyzing unit also obtains an error analysis of the words and/or phrases according to the consonant, vowel, and tone.

A word database is provided for storing word data of a user, such as a word or a phrase. The word database temporarily stores the words and phrases inputted by the user in a new word database, an unfamiliar word database, a familiar word database, a short-term word database and a long-term word database, according to the test result of the user. Accordingly, the words and/or phrases are dynamically stored at one of the word databases. The words and/or phrases are placed in the new word database when they are new, and are then are placed into different word databases according to the test result of the user. The classification of the word database is as follows:

1. A new word database for storing words and/or phrases not yet tested;

2. An unfamiliar word database for storing words and/or phrases having a low accuracy rate;

3. A familiar word database for storing words and/or phrases having a medium accuracy rate;

4. A short-term word database for storing words and/or phrases having a high accuracy rate; and

5. A long-term word database for storing words and/or phrases still having a high accuracy rate after a plurality of tests.

In the word databases mentioned above, the accuracy rate is adjustable according to the requirement of the user, or the accuracy rate can be replaced by a word familiarity level.

The user uses the input device and output device to operate the system. After the user is verified by the user login verification unit, the screening and sampling unit samples a test bank from the word database based on the test record of the user. The grading and timing unit calculates the answering time and determines if the user has correctly answered the questions. The recording and analyzing unit records and analyzes a test result of the user, and then stores the test result to the word database.

When the system provides a single user, one-to-one, or multiple user test, it samples the word databases to obtain a certain number of words and/or phrases. The system selects the words and/or phrases according to the number of users and selects them from the new word database, the unfamiliar word database, the familiar word database, the short-term word database and the long-term word database of each user based on a same sampling rule for the single user, one-to-one, or multiple user test. Accordingly, the words and/or phrases sampled conform to the principle of having the same difficulty level for all users.

A method and technique are provided which are adapted to the word familiarity level of the user and to store the words and/or phrases dynamically to different word databases according to the test record of the user. The system also samples words and/or phrases from the dynamic word databases to help the user do the test and stimulate his or her interest in learning the language.

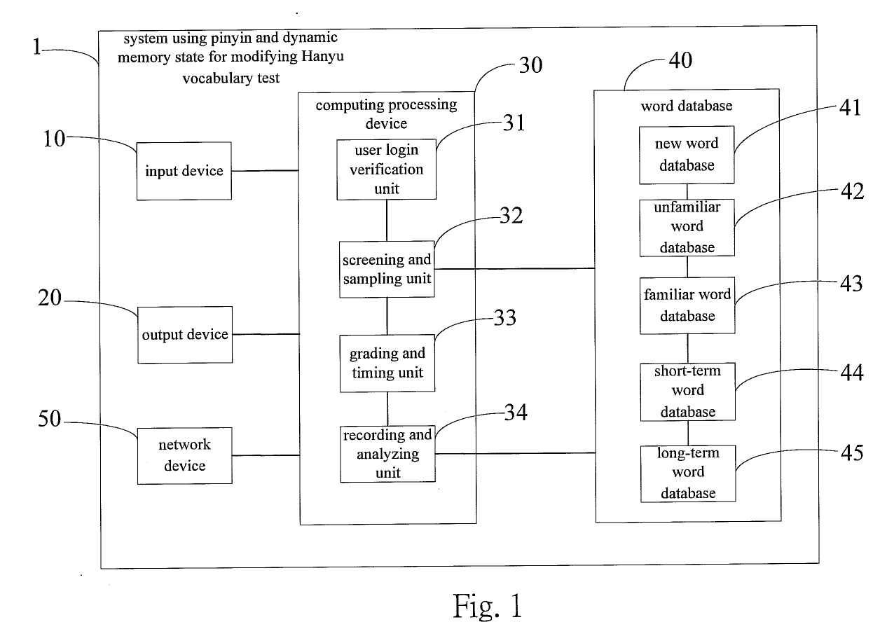

FIG. 1 illustrates a structural view of a system for using pinyin and a dynamic memory state for modifying a Hanyu vocabulary test according to the present invention. As shown in FIG. 1, the system 1 for using pinyin and dynamic memory state for modifying a Hanyu vocabulary test comprises an input device 10, an output device 20, a computing processing device 30, a word database 40, and a network device 50, wherein the computing processing device 30 comprises a user login verification unit 31, a screening and sampling unit 32, a grading and timing unit 33, and a recording and analyzing unit 34. The word database 40 comprises a new word database 41, an unfamiliar word database 42, a familiar word database 43, a short-term word database 44, and a long-term word database 45. The user can use the input device 10 and the output device 20 to operate the system 1. The input device 10 can be a mouse, a keyboard, a touch screen, or the like, and the output device 20 can be an LCD display or a touch screen. The network device 50 allows the system 1 to connect to the Internet. When the user logins the system 1, the user login verification unit 31 verifies the user and obtains a personal data, past test records and word and/or phrase data of the user, and create a new account if he or she is a new user. The screening and sampling unit 32 samples words and/or phrases from the word database 40 according to the user data, and can sample words and/or phrases from the new word database 41, unfamiliar word database 42, familiar word database 43, short-term word database 44, and long-term word database 45 based on a ratio for the user. The content of the test is to use a Chinese input method to represent a Chinese character with pinyin symbols comprising consonants, vowels and tones. The Chinese input method can be Hanyu Pinyin, Zhuyin Pinyin, or Tongyung Pinyin. The grading and timing unit 33 determines if the user correctly answers the questions, and calculates an answering time. The recording and analyzing unit 34 records and analyzes the test result to find out the error rate of the user with respect to the consonants, vowels and tones the user uses to answer the questions. Finally, the user receives the test analysis to know which words and/or phrases for which he or she often fails to give the correct answer, as well as the answering time/speed response, and the total accuracy rate, so as to enhance the learning effect.

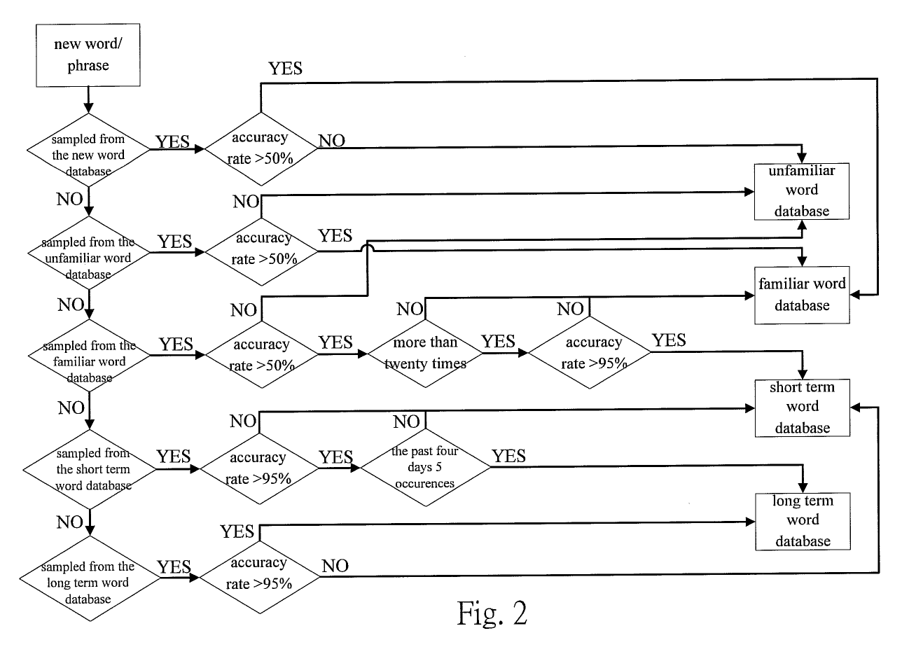

FIG. 2 illustrates a decision flow diagram for determining a word familiarity level of the system for using pinyin and dynamic memory state for modifying a Hanyu vocabulary test according to the present invention.

As shown in figure, a new word and/or phrase is stored at the new word database at first. If the user is tested with this new word and/or phrase and obtains an accuracy rate lower than 50%, the word and/or phrase is categorized into the unfamiliar word database. If the accuracy rate is higher than 50%, it is then categorized into the familiar word database.

If the word and/or phrase is sampled from the unfamiliar word database and has an accuracy rate lower than 50%, then it is categorized into the unfamiliar word database. If the accuracy rate is higher than 50%, then it is categorized into the familiar word database.

If the word and/or phrase is sampled from the familiar word database and has an accuracy rate lower than 50%, then it is categorized into the unfamiliar word database. If the accuracy rate is higher than 50%, then the system continues to determine if the accuracy rate is higher than 50% for at least 20 tests and, if not, then the word and/or phrase is categorized into the familiar word database. If so, then the system continues to determine if the accuracy rate is higher than 95% and, if not, then the word and/or phrase is categorized into the familiar word database. If so, then the word and/or phrase is categorized into the short-term word database.

If the word and/or phrase is sampled from the short-term word database and has an accuracy rate lower than 95%, then the word and/or phrase is categorized into the short-term word database. If the accuracy rate is higher than 95%, then the system continues to determine if the word and/or phrase appear five times in a four-day period of the test. If not, then the word and/or phrase is categorized into the short-term word database. If so, then it is categorized into the long-term word database.

If the word and/or phrase is sampled from the long-term word database and has an accuracy rate lower than 95%, then it is categorized into the short-term word database. If the accuracy rate is higher than 95%, then the word and/or phrase is categorized into the long-term word database.

This classification method helps the user know a word familiarity level for himself or herself. If the word and/or phrase is categorized into the unfamiliar word database, it means that the user is not familiar with the word and/or phrase. If the word and/or phrase is categorized into the familiar word database, it means the user knows the word and/or phrase but tends to make mistake. If the word and/or phrase is categorized into the short-term word database, it means that the user knows the word and/or phrase well. If the word and/or phrase is categorized into the long-term word database, it means that the user has memorized the word and/or phrase and would not forget the word and/or phrase. The accuracy rate described above is not fixed and can be adjusted by the user or replaced by a word familiarity level.

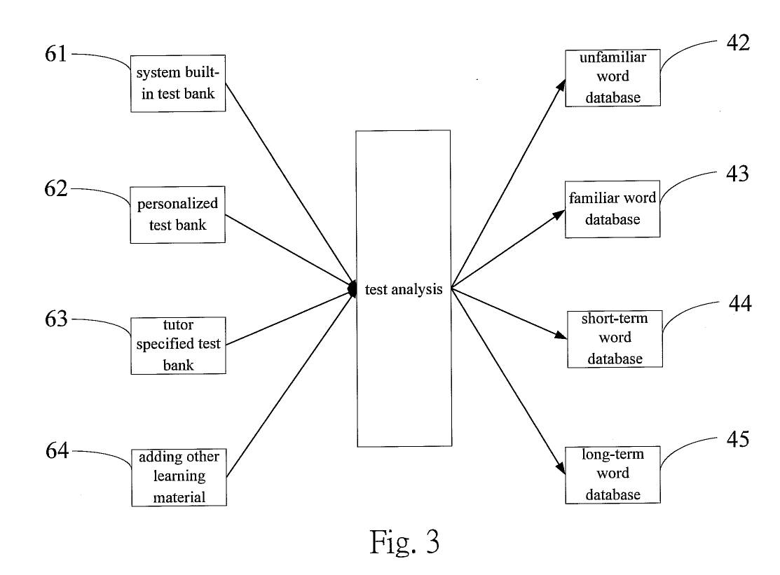

FIG. 3 illustrates a structural view of the system for using pinyin and dynamic memory state for modifying a Hanyu vocabulary test, wherein the structural view shows how the system categorizes new words and/or phrases and acquires new words and/or phrases from different resources. As shown in FIG. 3, new words and/or phrases could come from resources such as a system built-in test bank 51, which is a fundamental word and/or phrase test bank, a personalized test bank 52, which is specified by the user, a tutor specified test bank 53, which is created by the tutor to help the user, or other learning material 54, which is any available test bank. A new word and/or phrase from the resources noted above are categorized into different word databases according to a word familiarity level or an accuracy rate, wherein the words databases are:

1. A new word database 41 for storing words and/or phrases not yet tested;

2. And unfamiliar word database 42 for storing words and/or phrases having an accuracy rate of between 0% to 50%;

3. A familiar word database 43 for storing words and/or phrases having an accuracy rate of between 50% to 95%;

4. A short-term word database 44 for storing words and/or phrases having an accuracy rate of between 95% to 100%; and

5. A long-term word database 45 for storing words and/or phrases still having a high accuracy rate of between 95% to 100% after a plurality of tests.

When the system conducts the test, it samples words and/or phrases based on a ratio and a difficulty level suitable for the user. All of the words and/or phrases are initially placed at the new word database and are subsequently categorized into the unfamiliar word database 42, the familiar word database 43, the short-term word database 44, and the long-term word database 45, according to the test result. One of the characteristics of the present invention is that the system uses different word databases and classifies the databases to let the user know a word familiarity level of himself or herself and how to enhance his or her learning. The accuracy rate described above is not fixed and can be adjusted by the user or replaced by a word familiarity level.

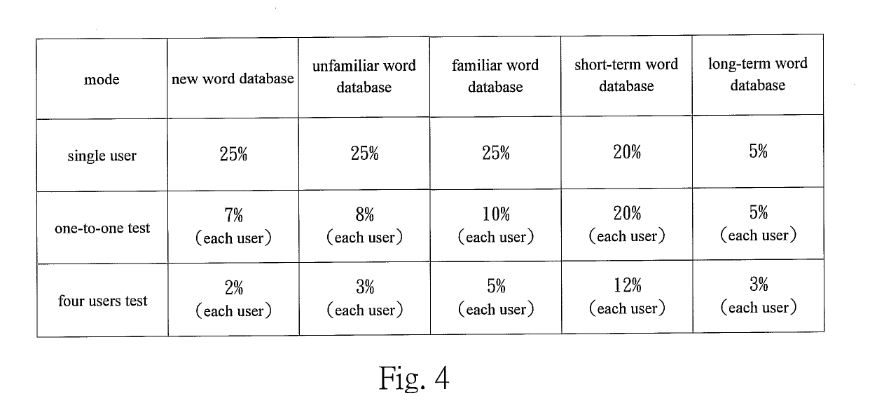

FIG. 4 illustrates a statistics table of the system for using pinyin and dynamic memory state for modifying a Hanyu vocabulary test. The table shows a sampling ratio according to different scenarios. As shown in FIG. 4, the system can set different ratios for sampling words and/or phrases from the word databases of each user. Because the word database is classified according to a word familiarity of the user or an accuracy rate, the system can increase the sampling ratio for the unfamiliar word database and reduce the sampling ratio for the long-term word database. Therefore, the system can provide a certain difficulty level and help the user learn progressively by adding new words and enhancing a word familiarity. For example, the system can sample 25% of the total words and/or phrases from the new word database. If the total number of samples is 100, then 25 questions are drawn from the new word database, 25 questions are drawn from the unfamiliar word database, 25 questions are drawn from the familiar word database, 20 questions are drawn from the short-term word database, and 5 questions are drawn from the long-term word database. If there are not enough questions in a certain word database, then the system samples the questions from a neighboring word database. It is noted that the ratio can be adjusted according to the number of users and the number of sampled words and/or phrases. In a one-to-one test, in order to be fair to both users, the systems samples words and/or phrases from the respective word databases of each user according to the same ratio. It is clear from FIG. 4 that the system samples 50% of the total words and/or phrases from the respective word databases of each user to form the test. The object is to increase the excitement in doing the test and to enhance competition of the two users in the right way. The two users can compete with each other and learn with each other at the same time.

Apart from the one-to-one test mode, the system can provide a multiple user test mode for four users or more. The sampling ratio is made equal for every user to ensure the fairness of the test. It is noted that the ratio is only an example of the present invention and can be adjusted by the user.

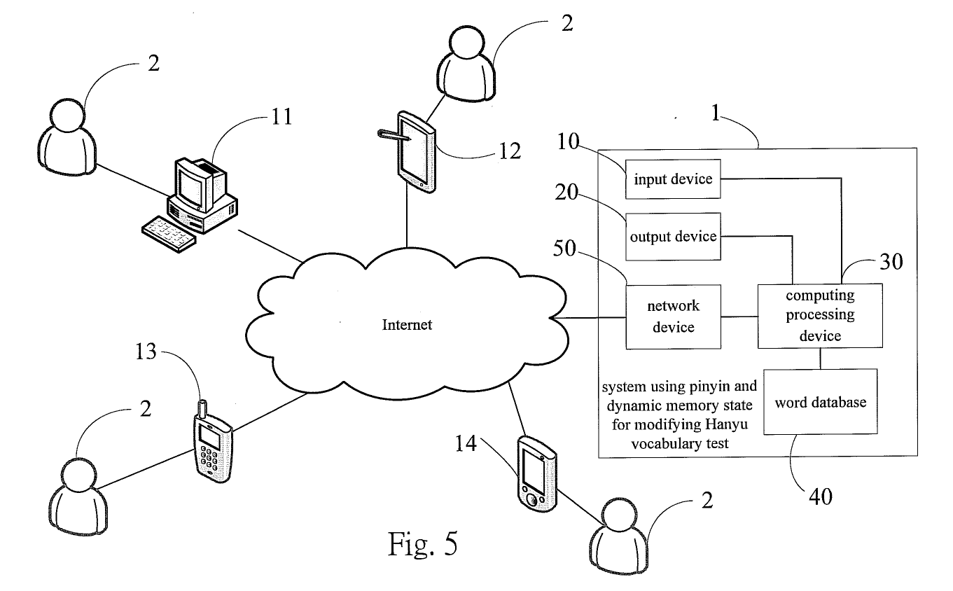

FIG. 5 illustrates a block diagram of the system for using pinyin and dynamic memory state for modifying a Hanyu vocabulary test according to the present invention. As shown in FIG. 5, the system 1 for using pinyin and dynamic memory state for modifying a Hanyu vocabulary test comprises a network device 50 to connect to the Internet. The system therefore allows different users 2 to operate the system 1 online for the test through different devices such as a home computer 11, a tablet PC 12, a smart phone 13, a personal digital assistant (PDA) 14, or any other devices having networking functions.

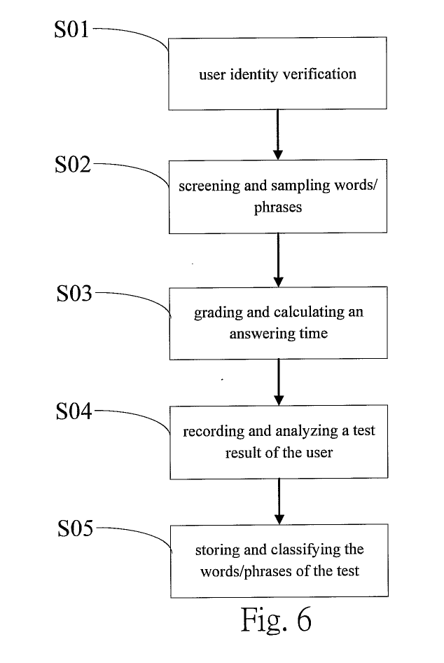

FIG. 6 illustrates a flow diagram of the system for using pinyin and dynamic memory state for modifying a Hanyu vocabulary test according to the present invention, wherein the steps are:

Step 1: user identity verification; i.e., verifying a user and obtaining a test record and a related word database when a user logs in to the system;

Step 2: screening the words database, i.e., screening the word database of the user based on a ratio rule obtained from the test record of the user, and sampling words and/or phrases from the word databases to form a test, wherein the word databases comprise the new word database, the unfamiliar word database, the familiar word database, the short-term word database, and the long-term word database;

Step 3: grading and calculating an answering time, i.e., providing an input device for the user to do the test, calculating an answering time, and determining if the user answers the questions of the test correctly;

Step 4: recording a test result and analyzing a word familiarity of the user after the user has done the test i.e., the system records a dynamic IP for a word or a phrase and analyzing the same to obtain a test record, a word and/or phrase familiarity, learning effect, and learning efficiency based on the test result; and

Step 5: storing the words and/or phrases of the test to the word databases according to the word familiarity or an accuracy rate of the user, wherein if the accuracy rate for the word and/or phrase is between 0% to 50%, then the word and/or phrase is stored in the unfamiliar word database, if the accuracy rate is between 50% to 95%, storing the word and/or phrase in the familiar word database, if the accuracy rate is between 95% to 100%, storing the word and/or phrase in the short-term word database, and if the accuracy rate is still 95% to 100% after a plurality of tests, storing the word and/or phrase in the long-term word database. It is noted that the accuracy rate described above is not fixed and can be adjusted by the user or replaced by a word familiarity level.

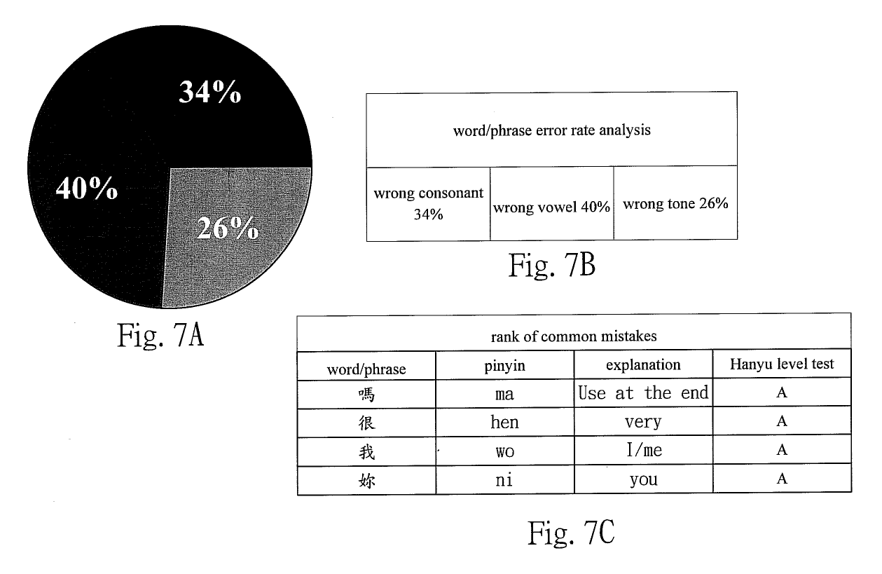

FIGS. 7A-7C illustrate error rate diagrams of the system for using pinyin and dynamic memory state for modifying a Hanyu vocabulary test according to the present invention. As is shown in the figures, after the user finishes the test, the present invention analyzes the test result to gather statistics of the error rate of the words and/or phrases with respect to consonants, vowels and tones, and then lists the words and/or phrases having the highest error rates to let the user be cautious about these words and/or phrases. The present invention can analyze the test result according to different criteria such as the answering time/speed, the accuracy rate, the accuracy rate for each words database, total number of words and/or phrases in each words database, learning effect, the number of tests, and so on.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A system for using pinyin and a dynamic memory state for modifying a Hanyu vocabulary test, the system using a Chinese input method for conducting the Hanyu vocabulary test, wherein the system comprises:
an input device for a user to operate the system;
an output device for displaying a view of the operation of the system;
a computing processing device, comprising:
a user login verification unit for verifying an identity of the user and a test record of the user;
a screening and sampling unit for screening a dynamic data storage based on a ratio rule obtained from the test record of the user and sampling at least one of words and phrases from the dynamic data storage to obtain a test bank;
a grading and timing unit for determining if the user answer the questions correctly and for calculating an answering time;
a recording and analyzing unit for recording a dynamic IP of a word or phrase from the test bank and the test record of the user, and for analyzing a word familiarity level and a learning effect of the user; and
a word database for storing word data of a user;
wherein the user uses the input device and output device to operate the system; and, after the user is verified by the user login verification unit, the screening and sampling unit samples the test bank from the word database based on the test record of the user, the grading and timing unit calculates the answering time and determines if the user answers the questions correctly, and the recording and analyzing unit records and analyzes a test result of the user, and then stores the test result to the word database.

2. The system for using pinyin and a dynamic memory state for modifying a Hanyu vocabulary test as claimed in claim 1, wherein the system stores the at least one of words and phrases to different word databases according to a accuracy rate specified by the user, the different word databases comprising:
a new word database for storing at least one of words and phrases not tested yet;
an unfamiliar word database for storing at least one of words and phrases having a low accuracy rate;
a familiar word database for storing at least one of words and phrases having a medium accuracy rate;
a short-term word database for storing at least one of words and phrases having a high accuracy rate; and
a long-term word database for storing at least one of words and phrases still having a high accuracy rate after a plurality of tests.

3. The system for using pinyin and a dynamic memory state for modifying a Hanyu vocabulary test as claimed in claim 1, wherein the Chinese input method uses consonants, vowels, and tones to represent a Chinese character, and the Chinese input method comprises Hanyu pinyin, Zhuyin pinyin, or Tongyong pinyin.

4. The system for using pinyin and a dynamic memory state for modifying a Hanyu vocabulary test as claimed in claim 1, wherein the system comprises a network device for providing network connections for a plurality of users to connect to the system.

5. The system for using pinyin and a dynamic memory state for modifying a Hanyu vocabulary test as claimed in claim 1, wherein the screening and sampling unit can sample at least one of words and phrases from each user's word database according to the number of users, to form a test and choose a difficulty level of the test.

6. A method for using pinyin and a dynamic memory state for modifying a Hanyu vocabulary test of a system, comprising the following steps:
verifying a user and obtaining a test record and a related word database when a user logs in to the system;
screening the word database of the user based on a ratio rule obtained from the test record of the user and sampling at least one of words and phrases from the word database to form a test;
providing an input device for the user to complete the test, calculating an answering time, and determining if the user answers the test questions correctly;
recording a test result and analyzing a word familiarity of the user after the user has completed the test; and
storing the at least one of words and phrases of the test to the word database according to the word familiarity of the user.

7. The method for using pinyin and a dynamic memory state for modifying a Hanyu vocabulary test of a system as claimed in claim 6, wherein the input device is a keyboard, a mouse, or a touch screen.

8. The method for using pinyin and a dynamic memory state for modifying a Hanyu vocabulary test of a system as claimed in claim 6, wherein the system stores the at least one of words and phrases to different word databases according to an accuracy rate specified by the user, the different word databases comprising: a new word database, an unfamiliar word database, a familiar word database, a short-term word database, and a long-term word database.

9. The method for using pinyin and a dynamic memory state for modifying a Hanyu vocabulary test of a system as claimed in claim 6, wherein the system allows a plurality of users to operate the system at the same time.

10. The method for using pinyin and a dynamic memory state for modifying a Hanyu vocabulary test of a system as claimed in claim 6, wherein the test is done by using a Chinese input method to represent a Chinese character with pinyin symbols and spelling the pinyin symbols of the Chinese characters correctly.
